(19) United States
(12) Patent Application Publication
(10) Pub. No.: US 2011/0097145 A1
(43) Pub. Date: Apr. 28, 2011

(54) CHASSIS MOUNT

(75) Inventor: Jason Shields, San Diego, CA (US)

(73) Assignee: DY4, Charlotte, NC (US)

(21) Appl. No.: 12/606,477

(22) Filed: Oct. 27, 2009

(51) Int. Cl. F16B 2/14

(52) U.S. Cl. 403/374.1

(57) ABSTRACT

A mounting assembly includes a chassis for receiving electronic components. First and second wedge members are coupled to a base panel of the chassis and each include an angled surface oriented towards a common direction. A mounting plate is adapted to be secured to a supporting surface, including first and second wedge receiving elements including complementary angled surfaces adapted to receive to the angled surfaces of the first and second wedge members. An intermediate member couples the first and second wedge receiving elements to maintain a fixed distance therebetween, and clamping structure is accessible from at least one face panel. The clamping structure is adapted to move the first and second wedge members towards the respective first and second wedge receiving elements such that engagement of the respective angled surfaces with the respective complementary angled surfaces applies a clamping force to the first and second wedge members.

### CROSS-REFERENCE TO RELATED APPLICATIONS

Not Applicable.

### FIELD OF THE INVENTION

The present invention relates generally to enclosures for electronic components, and more particularly, to an improved mounting assembly for the enclosure.

### BACKGROUND OF THE INVENTION

The military utilizes electronics enclosures, also referred to herein as a chassis, to house electronic gear used for command, control and communications. Other organizations also use such chassis. Advantageously, electronics enclosures are designed to provide shielding from electromagnetic interference (EMI) that can interrupt proper operation of the sensitive electronic equipment. The shielding also prevents electromagnetic signals generated from equipment from being intercepted or used to pinpoint the location where such equipment is housed.

In military or other applications, such electronics chassis are often re-locatable and rapidly deployable to support an intended mission or objective. Typically the chassis are mounted on prime movers such as light or medium trucks, tanks, ships, aircraft, etc. It is often desirable that the chassis be transported while mounted on a prime mover. However, it is common that the chassis are removed and re-installed in a prime mover while in the field, such as for maintenance, repair, and/or replacement. Often, the chassis are mounted in tight locations that are may not be easily accessible.

### BRIEF SUMMARY OF THE INVENTION

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with one aspect of the present invention, a mounting assembly includes a chassis for receiving electronic components, including at least one face panel and a base panel. The mounting assembly further includes a first wedge member coupled to the base panel of the chassis and including an angled surface, and a second wedge member coupled to the base panel of the chassis and including an angled surface. The respective angled surfaces of each of the first and second wedge members are oriented towards a common direction. The mounting assembly further includes a mounting plate adapted to be secured to a supporting surface, including a first wedge receiving element including a complementary angled surface adapted to receive to the angled surface of the first wedge member, and a second wedge receiving element including a complementary angled surface adapted to receive to the angled surface of the second wedge member. An intermediate member couples the first and second wedge receiving elements to maintain a fixed distance therebetween, and clamping structure is accessible from the at least one face panel. The clamping structure is adapted to move the first and second wedge members towards the respective first and second wedge receiving elements such that engagement of the respective angled surfaces with the respective complementary angled surfaces applies a clamping force to the first and second wedge members.

In accordance with another aspect of the present invention, a mounting assembly including a chassis for receiving electronic components, including at least one face panel and a base panel. The mounting assembly further includes a first wedge member coupled to the base panel of the chassis and including a plurality of angled surfaces with at least two of the plurality of angled surfaces being oriented at an angle relative to each other. The mounting assembly further includes a second wedge member coupled to the base panel of the chassis and including an angled surface oriented towards a common direction with at least one of the plurality of angled surfaces of the first wedge member. The mounting assembly further includes a mounting plate adapted to be secured to a supporting surface, including a first wedge receiving element including a plurality of complementary angled surfaces adapted to receive the plurality of angled surfaces of the first wedge member. A second wedge receiving element includes a complementary angled surface adapted to receive to the angled surface of the second wedge member, and an intermediate member couples the first and second wedge receiving elements. Clamping structure is accessible from the at least one face panel and is adapted to move the first and second wedge members towards the respective first and second wedge receiving elements such that engagement of the respective angled surfaces with the respective complementary angled surfaces applies a clamping force to the first and second wedge members.

In accordance with another aspect of the present invention, a mounting assembly includes a chassis for receiving electronic components, including at least one face panel, and a base panel including a recess. The mounting assembly further includes a first wedge member coupled to the base panel of the chassis and including an angled surface, a second wedge member coupled to the base panel of the chassis and including an angled surface, and a third wedge member coupled to the base panel of the chassis and including an angled surface. The respective angled surfaces of each of the first, second, and third wedge members are oriented towards a common direction. The mounting assembly further includes a mounting plate at least partially receivable within the recess of the base panel and adapted to be secured to a supporting surface. The mounting plate includes a first wedge receiving element including a complementary angled surface adapted to receive to the angled surface of the first wedge member, a second wedge receiving element including a complementary angled surface adapted to receive to the angled surface of the second wedge member, and a third wedge receiving element including a complementary angled surface adapted to receive to the angled surface of the third wedge member. An intermediate member couples the first and second wedge receiving elements to maintain a fixed distance therebetween, and the intermediate member is located between the second and third wedge receiving elements. Clamping structure is accessible from the at least one face panel and adapted to move the first, second, and third wedge members towards the respective first, second, and third wedge receiving elements such that engagement of the respective angled surfaces with the respective complementary angled surfaces applies a clamping force to the first, second, and third wedge members.

It is to be understood that both the foregoing general description and the following detailed description present example and explanatory embodiments of the invention, and are intended to provide an overview or framework for understanding the nature and character of the invention as it is claimed. The accompanying drawings are included to provide a further understanding of the invention and are incorporated into and constitute a part of this specification. The drawings illustrate various example embodiments of the invention, and together with the description, serve to explain the principles and operations of the invention.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 illustrates a perspective view of an example chassis being mounted to a support surface via an example mounting plate;

FIG. 2 illustrates an exploded view of the example chassis of FIG. 1;

FIG. 3 illustrates a top view of an example mounting plate;

FIG. 4 illustrates a top view of an example wedge member;

FIG. 5A illustrates a top view of another example wedge member;

FIG. 5B illustrates a top view of yet another example wedge member;

FIG. 6A illustrates a side view of the example chassis in a disengaged position;

FIG. 6B is similar to FIG. 6A, but illustrates a bottom view;

FIG. 7A illustrates a side view of the example chassis in an engaged position;

FIG. 7B is similar to FIG. 7A, but illustrates a bottom view;

FIG. 8A illustrates a detail view of an example wedge member and wedge receiving element in a disengaged position; and

FIG. 8B is similar to FIG. 8A, but illustrates the wedge member and wedge receiving element in an engaged position.

### DESCRIPTION OF EXAMPLE EMBODIMENTS

Example embodiments that incorporate one or more aspects of the present invention are described and illustrated in the drawings. These illustrated examples are not intended to be a limitation on the present invention. For example, one or more aspects of the present invention can be utilized in other embodiments and even other types of devices. Moreover, certain terminology is used herein for convenience only and is not to be taken as a limitation on the present invention. Still further, in the drawings, the same reference numerals are employed for designating the same elements.

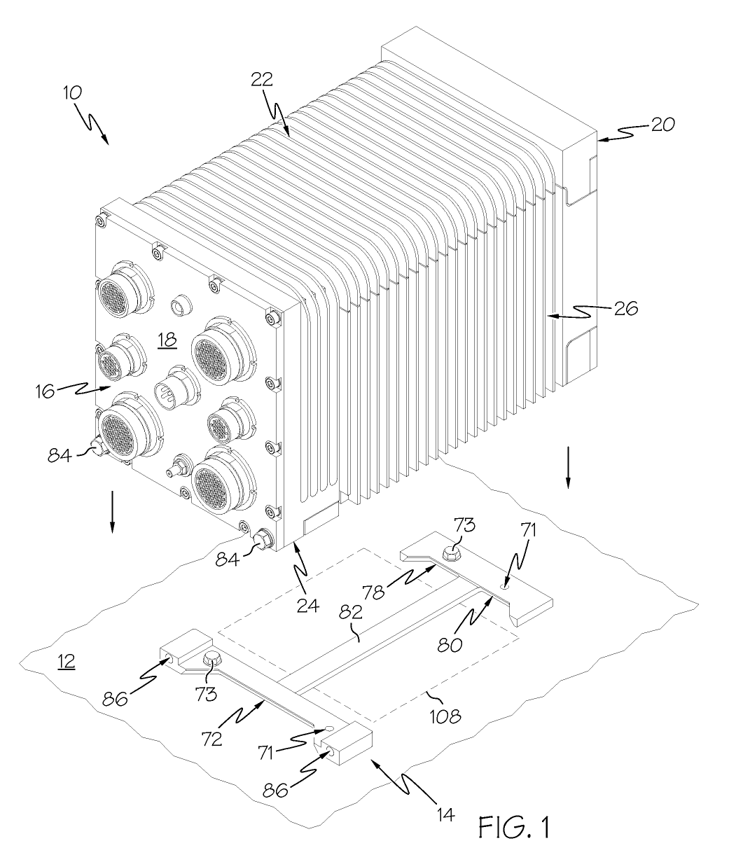

Turning to the example shown in FIG. 1, a mounting assembly is illustrated that includes a perspective view of an example chassis 10, which can also be referred to as an enclosure, being mounted to a support surface 12 via an example mounting plate 14 is illustrated schematically. As shown, the supporting surface 12 can be disposed generally underneath the chassis 10, though it is to be understood that the supporting surface can also be disposed about any of other side (i.e., rear, top, sides, etc.) of the chassis 10. In general, the chassis 10 houses electronic gear used for command, control and communications, or other functions, and to provide an embedded computing system. The chassis 10 is of a type designed to meet the harsh environments of many military and industrial computing applications.

Electronic components, such as circuit cards and/or other circuitry (not shown) can be installed in the system chassis 10 and are substantially isolated from external environmental conditions such as humidity, dust and sand, etc. Cooling of the electronic components can be accomplished by conduction and/or convection. In one example, cooling can be provided by forced air and/or thermal transfer between the card edge of conduction-cooled 3U cPCI cards and one or more walls of the system chassis 10. EMI filters and gaskets can be employed for system security and increased reliability. Where desired, the walls of the chassis can be adapted to provide electrical shielding, such as electromagnetic interference, or the like. The chassis 10 can be customized to specific requirements, such as non-standard voltage power supplies, back plane wiring, special form-factor footprints, custom enclosures, and/or special environmental considerations. Similarly, the chassis 10 can include specific wiring, various front or rear panel connectors 16 and/or back planes (not shown).

The chassis 10 can be manufactured with relatively high strength materials and fasteners. More specifically, the chassis 10 can be formed of various materials that have desirable physical and electrical characteristics to provide an enclosure that is corrosion resistant and resistant to damage, such as various metals, hard rubbers, composites, and/or even a thermoplastic composition, such as ABS or the like. Generally, the chassis 10 can be formed of various materials having desired characteristics, namely tensile strength, impact and rupture resistance, surface hardness, rigidity, heat resistance, low temperature properties, chemical resistance, suitable electrical characteristics, and/or non-flammability. It can be beneficial to utilize like materials in forming the chassis 10 that have similar thermal expansion properties.

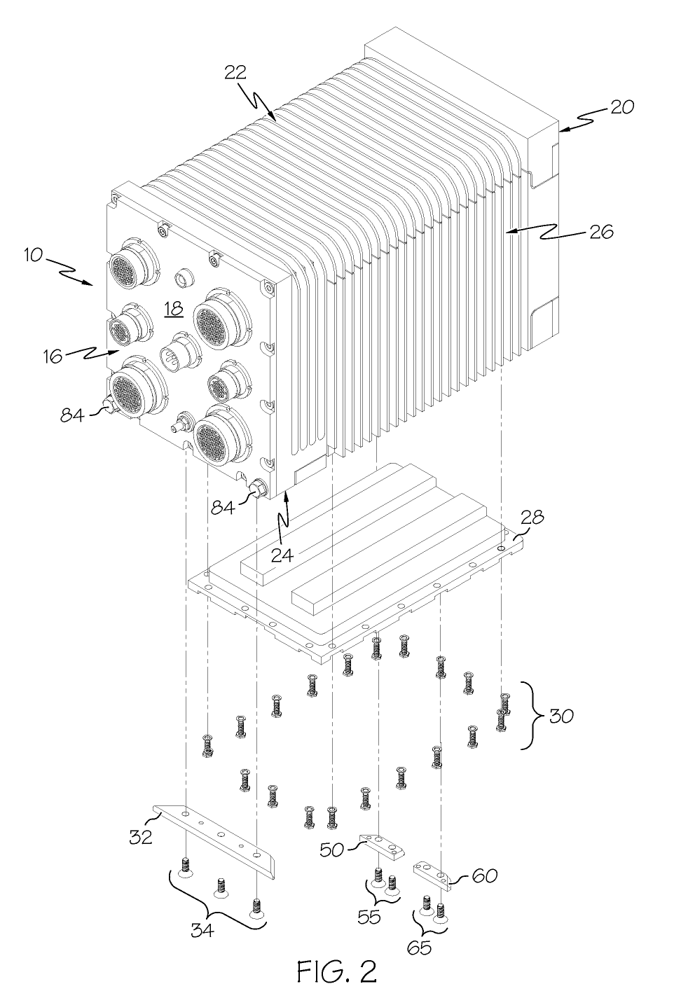

An example chassis 10 is illustrated in FIG. 1 and can be defined by a plurality of panels, including a face panel 18, a rear panel 20, a top panel 22, a base panel 24, and a plurality of side panels 26. Any or all of the panels can be separate for formed together. Additionally, any or all of the panels can include structure to provide a direct or indirect thermal path for heat exchange, such as cooling fins to provide passive cooling for the electronic components of the chassis 10. The base panel 24 can form a bottom surface of the chassis 10 that can be adapted to rest on or about the support surface 12. In one example, as shown in FIG. 2, a portion of the base panel 24 can be removable, such as a cover plate 28. The cover plate 28 can be removably or non-removably coupled to the chassis 10, such as by various mechanical fasteners 30, adhesives, welding, etc. The cover plate 28 can be removed to provide access to an interior of the chassis 10, and/or can provide a thermal conduction cooling plate for the chassis 10. For example, the cover plate 28 can include various thermal conduction structure adapted to facilitate the transfer thermal energy into or out of the chassis 10. In addition or alternatively, a portion of the base panel 24, which may or may not include the cover plate 28, can include a recess 29 adapted to at least partially receive the mounting plate 14. Thus, the chassis 10 can be coupled to the mounting plate 14, while remaining flush relative to the supporting surface 12, although some portions may not be flush. In addition or alternatively, the cover plate 28 can be adapted to be retrofit onto an existing chassis 10 that otherwise may not be compatible with the mounting plate 14. Additional spacers, shims, adapters, etc. can also be utilized.

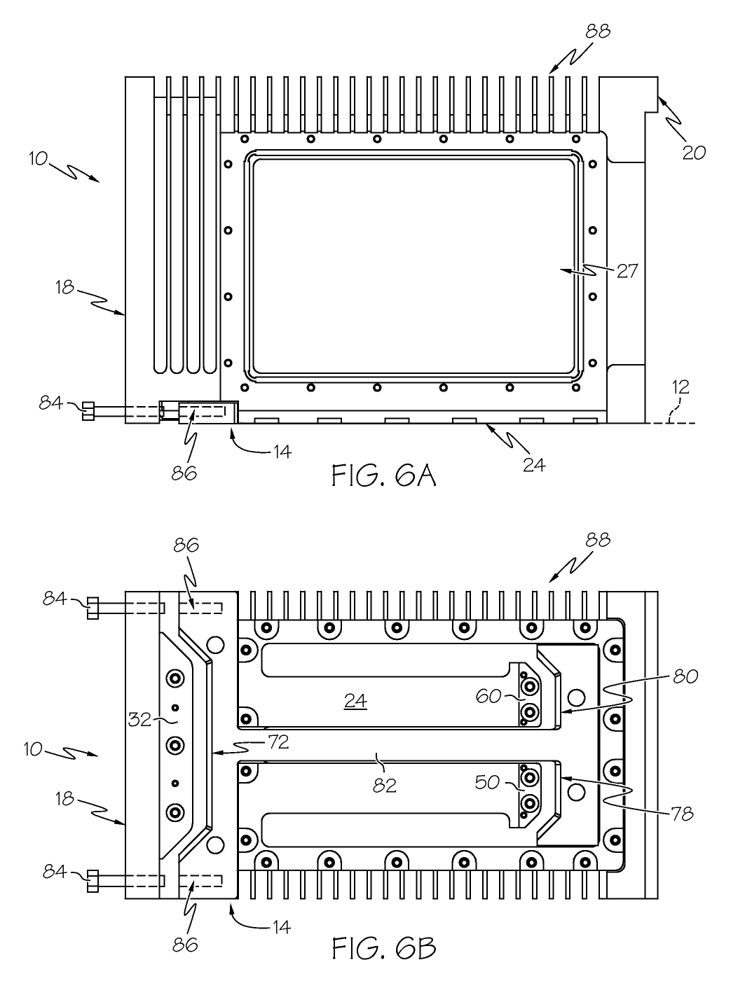

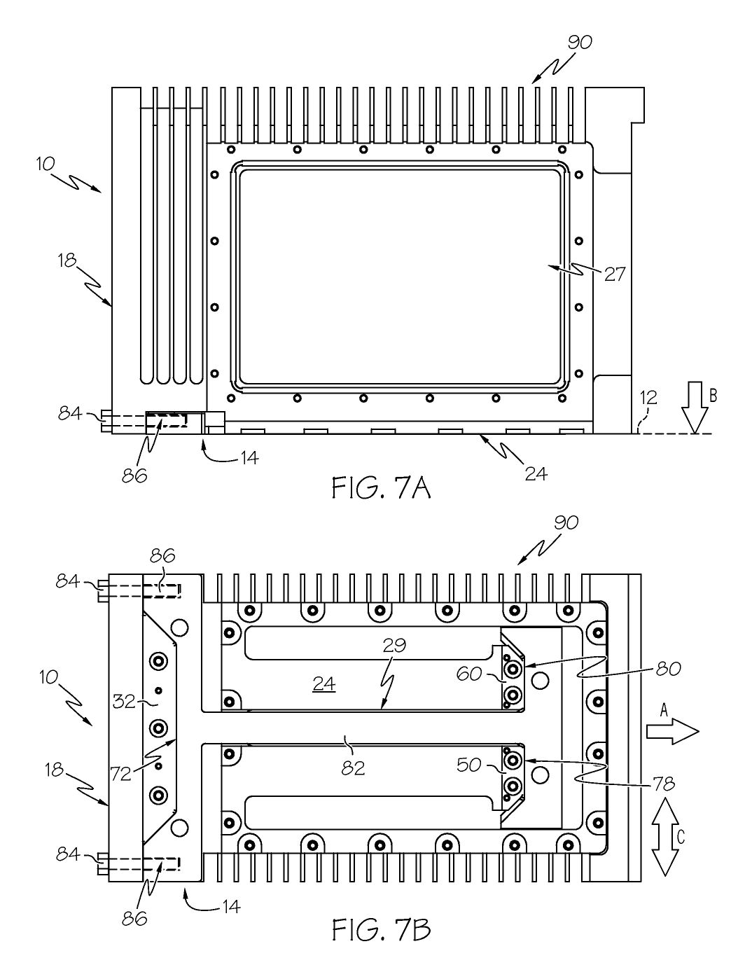

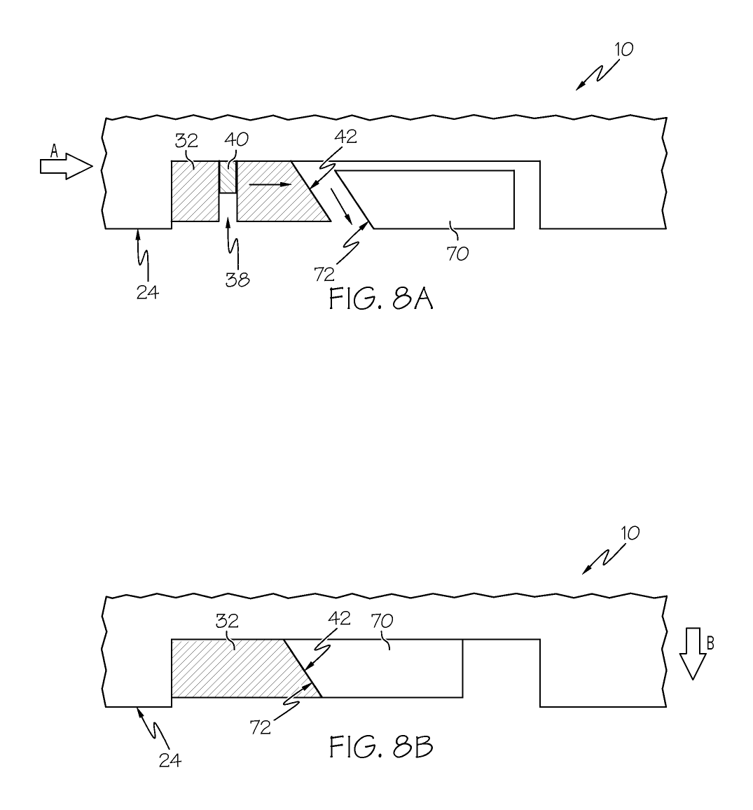

Though shown as having a generally rectangular geometry, it is to be understood that the chassis 10 can have various other geometries. Though not shown, the face panel 18 (or other panel) can be provided with a handle or the like for moving the chassis 10. In addition or alternatively, at least one of the panels, such as the side panel 26, can be provided with an access opening 27 (see FIG. 6A) through which one or more of the electronic components (not shown) can be installed, such as in a card guide (not shown) or the like. A cover or door (shown removed in FIG. 6A) can form a portion of the side panel 26 and can be used to close the access opening. The door can be removably attached with various mechanical fasteners, adhesives, etc. Additional access openings can be provided by various other panels, if desired, such as the cover plate 28.

The electronic components, such as semiconductor components, produce thermal energy (i.e., heat) during operation. Typically, the thermal energy is an undesirable by-product, and can be detrimental to operation of an electronic apparatus. As such, it is desired to remove such excessive thermal energy. One approach to removing thermal energy is to direct a flow of thermal energy to a heat sink portion of the electronic apparatus. The heat sink may be part of the device chassis, etc. The end result is that thermal energy is moved away from the electronic components that produce the thermal energy and which may be adversely affected by the thermal energy if the thermal energy was allowed to rise to an undesirable level.

One approach to diverting thermal energy utilizes a device that conducts thermal energy. The device is placed with one portion adjacent (e.g., in-contact with) the electronic component, and another portion in contact with a heat sink. For example, cooling of the electronic components within the chassis 10 can be accomplished by conduction and/or convection, such as by forced air over and/or thermal transfer through the cover plate 28. In one example, the supporting surface 12 can provide heat exchanger structure, such as a thermally cooled structure 108 (i.e., a cold plate or the like), that is thermally coupled to the cover plate 28 when the chassis 10 is in an engaged position. Thus, the cover plate 28 can provide heating or cooling of the chassis 10 and electronic components, as desired. In other examples, self-contained heat exchanger structure (not shown) may be imbedded in the chassis 10 to extract heat and provide for cooling of the enclosed electrical components (or alternatively, can provide heat for heating, if desired).

It is common that while the chassis 10 is mounted in a tight location that is not easily accessible, the chassis 10 may be removed and re-installed while in the field, such as for maintenance, repair, and/or replacement. Often, the chassis 10 may be mounted in such as fashion so as to be accessible from as few as one direction, such as from the top and/or front when being mounted to the support surface 12, though can also be accessible from other directions.

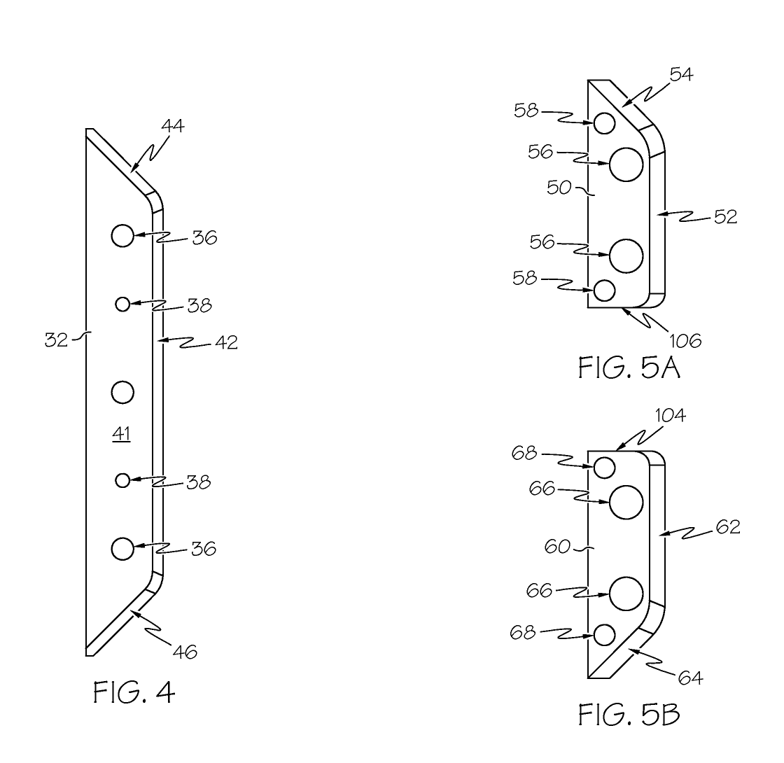

The mounting assembly can include additional structure. Turning to FIGS. 2 and 4, the chassis can include at least one wedge member to couple the chassis 10 to the supporting surface 12. In one example, a first wedge member 32 can be coupled to the base panel 24. The first wedge member 32 can be removably or non-removably coupled to various portions of the base panel 24, such as by various mechanical fasteners 34, adhesives, welding, etc. The first wedge member 32 can be coupled to various non-removable (as shown), or even removable, portions of the base panel 24, such as the cover plate 28. Additionally, the first wedge member 32 can extend outwardly from the of the chassis 10, or may even be received within a recess of the base panel 24 (see FIG. 8A). The first wedge member 32 can include one or more apertures 36, such as holes, for receiving various mechanical fasteners 34, and/or can include one or more apertures 38, such as holes, each adapted to receive a projection 40 (see FIG. 8A) extending from the base panel 24. Any of the apertures 36, 38 can extend partially or completely through the first wedge member 32. Engagement of the projection(s) 40 within the aperture(s) 38 can inhibit, such as prevent, relative movement of the first wedge member 32 relative to the base panel 24, and/or may provide additional strength to the first wedge member 32 (i.e., shear loading, etc.).

Additionally, the first wedge member 32 can include an angled surface 42. The angled surface 42 can be provided at an angle relative to a top surface 41 of the first wedge member 32. In addition, the first wedge member 32 can include a plurality of angled surfaces 42, 44, 46, with at least two of the plurality of angled surfaces being oriented at an angle relative to each other. For example, as shown, each of the angled surfaces 42, 44, 46 can be oriented at an angle relative to each other. The angled surface 42 can be a front angled surface, while each of the other angled surfaces 44, 46 can be side angled surfaces. Each of the angled surfaces can be angled generally downwardly relative to the top surface 41. For example, as shown, any of the angled surfaces 42, 44, 46 can form complex angles defined by two, or even three, axes.

In addition, as shown in FIGS. 2 and 5A-5B, at least one other wedge member can be coupled to the base panel 24. For example, a second wedge member 50 and/or even a third wedge member 60 can each be coupled to the base panel 24 and can include one or more angled surfaces, such as a front angled surface 52, 62 and/or at least one side angled surface 54, 64. The second and/or third wedge members 50, 60 can be separate from the first wedge member 32 and each other to allow for individual replacement, and/or for increased mechanical tolerances, etc. The first wedge member 32 can be removably or non-removably coupled to non-removable or even removable portions of the base panel 24, such as the cover plate 28 (as shown), by various mechanical fasteners 55, 65, adhesives, welding, etc. Either or both of the second and third wedge members 50, 60 can include one or more apertures 56, 66, such as holes, for receiving various mechanical fasteners 55, 65, and/or can include one or more apertures 58, 68, such as holes, each adapted to receive a projection (not shown, but similar to the projection 40 shown in FIG. 8A) extending from the base panel 24. Any of the apertures 56, 66, 58, 68 can extend partially or completely through the second and third wedge members 50, 60. In another example, any or all of the wedge members 32, 50, 60 can be formed with the chassis 10.

In addition, the side angled surfaces 54, 64 can be oriented at an angle relative to the front angled surfaces 52, 62 of the second and third wedge members 50, 60. Further, each of the angled surfaces 52, 54, 62, 64 can be angled generally downwardly relative to a respective top surface 51, 61 of the second and third wedge members 50, 60. For example, as shown, any of the angled surfaces 52, 54, 62, 64 can form complex angles defined by two, or even three, axes.

The various angled surfaces of the first, second, and third wedge members 32, 50, 60 can be oriented variously relative to each other. In one example, the front angled surfaces 42, 52, 62 of each wedge member 32, 50, 60 can all be oriented generally towards a common direction, such as generally towards the direction in which the chassis 10 will be installed onto the supporting surface 12 (i.e., indicated by arrow A in FIG. 7B). Thus, the front angled surfaces 42, 52, 62 can be adapted to inhibit, such as prevent, undesired movement of the chassis 10 along the direction of arrow A (or even the opposite direction) when installed on the supporting surface 12. Similarly, the side angled surfaces 44, 46, 54, 64 can be adapted to inhibit, such as prevent, undesired movement of the chassis 10 along the directions in which they are oriented, such as directions generally transverse that of arrow A (e.g., see arrow C in FIG. 7B). For example, the side angled surfaces 44, 46 of the first wedge member 32 can each be oriented in the same general direction as the side angled surfaces 54, 64 of the second and third wedge members 50, 60, respectively. In addition, as shown in FIG. 2, the side angled surfaces 54, 64 of the second and third wedge members 50, 60 can be angled away from each other in generally opposite directions, as will be discussed more fully herein.

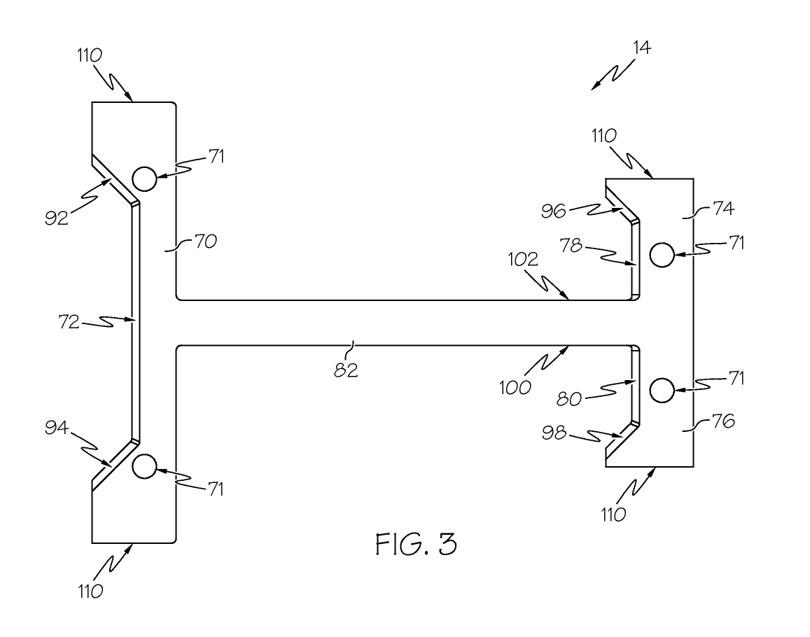

Turning now to FIGS. 2-3, the mounting plate 14 can be adapted to be removably or non-removably secured to the supporting surface 12 to thereby secure the chassis 10 to the supporting surface 12. In one example, the mounting plate 14 can include one or more apertures 71, such as holes, for receiving various mechanical fasteners 73 (i.e., bolts, screws, etc.) for securing the mounting plate 14 to the supporting surface 12, though other methods can be used, such as adhesives, welding, etc.

The mounting plate 14 can further include a first wedge receiving element 70 including a complementary angled surface 72 adapted to receive the front angled surface 42 of the first wedge member 32. In addition, the mounting plate 14 can also include at least one other wedge receiving element, such as second and/or third wedge receiving elements 74, 76. For example, the second and third wedge receiving elements 74, 76 can each include a complementary angled surface 78, 80 to receive, respectively, the front angled surfaces 52, 62 of the second and third wedge members 50, 60. The second and/or third wedge receiving elements 74, 76 can be coupled to each other and the first wedge receiving element 70, as shown, or may even be provided as separate elements to allow for individual replacement, and/or for increased mechanical tolerances, etc.

Further, the mounting plate 14 can include an intermediate member 82 coupling the first, second, and/or third wedge receiving elements 70, 74, 76 to maintain a fixed distance therebetween. Thus, the complementary angled surfaces 72, 78, 80 can be separated from each other by substantially fixed distances. In one example, the first, second, and/or third wedge receiving elements 70, 74, 76 can be integrally formed together. In another example, the second and third wedge receiving elements 74, 76 can be separated from each other by the intermediate member 82.

The mounting plate 74 can further include clamping structure accessible from the at least one face panel 18 and adapted to move the first, second, and/or third wedge members 32, 50, 60 towards the respective first, second, and/or third wedge receiving elements 70, 74, 76, respectively. In one example, the clamping structure can include at least one bolt 84 (or other mechanical fastener) extending through the at least one face panel 18. As shown in FIG. 2, the clamping structure can include a pair of bolts 84 extending through the face panel 18 and having the bolt heads accessible from the exterior of the face panel 18. In other examples, not shown, the clamping structure can include various other elements, such as a handle-operated cam lock or the like that may obviate the need for extra tools and the like. In addition or alternatively, the clamping structure can include lock structure (not shown) for inhibiting inadvertent release of the clamping structure. Because the chassis 10 may be mounted in such as fashion so as to be accessible from the top and/or front when being mounted to the support surface 12, providing the clamping structure via the face panel 18 permits a user to mount and secure the chassis 10 to the supporting surface 12 from as little as one direction (i.e., from the front). Thus, where a plurality of chassis 10 are provided in a relatively small location, each chassis 10 can be individually removed and/or replaced from the front side without disturbing any of the other adjacent chassis 10.

As shown in FIG. 1, the at least one bolt 84 can extend through the face panel 18 such that the bolt head is accessible, and can threadingly engage a threaded bore 86 coupled to the first wedge receiving element 70. As shown, the first wedge receiving element 70 can include a pair of threaded bores 86 each adapted to threadingly engage a separate one of the pair of bolts 84. The threaded bores 86 are shown disposed towards the outside edge of the first wedge receiving element 70, though it is to be understood that the bores 86 can be disposed variously on the mounting plate 14. In addition or alternatively, where the clamping structure includes various other elements, the mounting plate 14 can include corresponding structure for engagement therewith.

Turning to FIGS. 6A-7B, rotation of the at least one bolt 84 in a first direction (i.e., a clamping direction), via threaded engagement with the threaded bore 86, can draw each of the first, second, and/or third wedge members 32, 50, 60 towards the respective first, second, and/or third wedge receiving elements 70, 74, 76. Engagement of the wedge members with the wedge receiving elements thereby causes engagement of the chassis 10 with the mounting plate 14 to secure the chassis 10 to the supporting surface 12. For example, in FIGS. 6A-6B, the chassis 10 is illustrated in a disengaged position 88, wherein the bolts 84 are not received within the threaded bores 86 and the wedge members are not engaged with the wedge receiving members. Thus, the chassis 10 can be removed from the mounting plate 14 and the supporting surface 12. Turning to FIGS. 7A-7B, the chassis 10 is illustrated in an engaged position 90, wherein the bolts 84 are threadingly received within the threaded bores 86. The chassis 10 is moved in the direction of arrow A such that each of the wedge members are engaged with the respective wedge receiving members. Thus, the chassis 10 is secured to the supporting surface 12 via the mounting plate 14. On the other hand, rotation of the at least one bolt 84 in a second direction (i.e., an un-clamping direction) can withdraw each of the first, second, and/or third wedge members 32, 50, 60 from the respective first, second, and/or third wedge receiving elements 70, 74, 76 to thereby disengage the chassis 10 from the supporting surface 12. Alternatively, removal of the bolt 84 may keep the chassis 10 in the engaged position 90 until the chassis 10 is physically removed by a user. It is to be understood that when the chassis 10 is in the engaged or disengaged positions 88, 90 with the mounting plate 14, the wedge members may still partially abut portions of the wedge receiving members.

Engagement of the respective angled surfaces 42, 52, 62 with the respective complementary angled surfaces 72, 78, 80 can apply a clamping force to the first, second, and/or third wedge members 32, 50, 60 to thereby secure the chassis 10 to the supporting surface 12. In one example, the complementary angled surfaces 72, 78, 80 of the first, second, and/or third wedge receiving elements 70, 74, 76 can be angled generally upwardly to apply a generally downwardly directed force upon the first, second, and/or third wedge members 32, 50, 60, respectively. Thus, by rotating the bolt(s) 84 in the clamping direction, engagement of the respective angled surfaces 42, 52, 62 with the respective complementary angled surfaces 72, 78, 80 can translate the tensile force of the bolt(s) 84 in the axial direction into the clamping force, along the direction of arrow B, to thereby secure the chassis 10 to the mounting plate 14. Thus, the clamping force can inhibit, such as prevent, inadvertent movement of the chassis along the direction of arrow B.

For example, turning briefly to FIGS. 8A-8B, operation of the clamping structure will move the chassis 10 generally along the direction of arrow A (i.e., shown moving towards the right in FIG. 8A) to draw the first wedge member 32 generally towards the first wedge receiving member 70. The complementary angled surface 72 is angled generally upwardly to apply a generally downwardly directed force (i.e., along the direction of arrow B) upon the front angled surface 42 of the first wedge member 32. Thus, the chassis 10 will be drawn downwards generally along the direction of arrow B to thereby secure the chassis 10 to the supporting surface 12.

Engagement of the front angled surfaces 42, 52, 62 with the respective wedge receiving elements 70, 74, 76 can cause movement of the chassis 10 generally along the direction of arrow A, and can inhibit, such as prevent, inadvertent movement of the chassis along the direction of arrow A (or even the opposite direction). However, such engagement may or may not inhibit transverse movement of the chassis 10. Thus, any or all of the wedge receiving elements 70, 74, 76 can further include a plurality of complementary angled surfaces corresponding to the plurality of angled surfaces of the wedge members 32, 50, 60. For example, the first wedge receiving element 70 can include one or more complementary side angled surfaces 92, 94 that correspond respectively to the side angled surfaces 44, 46 of the first wedge member 32. Similarly, either or both of the second and third wedge receiving elements 78, 80 can include one or more complementary side angled surfaces 96, 98 that correspond, respectively, to the side angled surfaces 54, 62 of the second and third wedge members 50, 60.

Because the side angled surfaces 44, 46, 54, 64 are each oriented at an angle relative to the respective front angled surfaces 42, 52, 62, engagement of the side angled surfaces 44, 46, 54, 64 with the complementary side angled surfaces 92, 94, 96, 98 can inhibit, such as prevent, inadvertent movement of the chassis along a direction generally transverse (i.e., see arrow C) to the direction of arrow A. Thus, upon engagement of the clamping structure (e.g., bolts 84 and threaded bores 86) the chassis 10 can be inhibited, such as prevented, from inadvertent movement in at least two, or even three, axes (i.e., see arrows A, B, C). Still, any or all of the side angled surfaces 44, 46, 54, 64 may or may not engage the complementary side angled surfaces 92, 94, 96, 98 when the respective front angled surfaces 42, 52, 62 are engaged with the respective wedge receiving elements 70, 74, 76. For example, any or all of the side angled surfaces 44, 46, 54, 64 may be used to facilitate alignment of the chassis 10 relative to the mounting plate 14.

Further, because any of the angled surfaces 42, 44, 46 can form complex angles defined by two or even three axes, the clamping force can be thereby directed upon multiple force vectors along two, or even three, axes. For example, the engagement of the front angled surfaces 42, 52, 62 with the respective wedge receiving elements 70, 74, 76 can direct portions of the clamping force along at least two force vectors, such as primarily along the axes of arrows A and B. Similarly, the engagement of the side angled surfaces 44, 46, 54, 64 with the complementary side angled surfaces 92, 94, 96, 98 can direct portions of the clamping force along at least three force vectors, such as along the axes of arrows A, B, and C.

The chassis 10 can include various other features. For example, the intermediate member 82 of the mounting plate 14 can include a pair of side edges 100, 102 extending along the axial length thereof. The side edges 100, 102 can be relatively straight, as shown, or can include other geometry. Similarly, the second and third wedge members 50, 60 can each include a corresponding side edge 104, 106 for sliding engagement with the side edges 100, 102 of the intermediate member 82. Thus, when the chassis 10 is moved along the direction of arrow A during engagement or disengagement with the mounting plate 14, the engagement of the side edges 100, 102 with the corresponding side edge 104, 106 can guide the movement of the chassis 10. Similarly, the engagement of the side edges 100, 102 with the corresponding side edge 104, 106 can further inhibit, such as prevent, movement of the chassis 10 along the direction of arrow C. In addition or alternatively, the mounting plate 14 can include various other side edges 110 for engagement with corresponding edges of the chassis 10 for guiding and/or restricting movement, etc.

As previously discussed herein, cooling of the chassis 10 and the electronic components therein can be accomplished by conduction and/or convection, such as by thermal transfer between one or more walls of the system chassis 10 and a heat exchanger. Thus, a portion of the bottom surface 24 can be adapted to be thermally coupled to a temperature control device 108 shown schematically in FIG. 1, such as a heat exchanger for cooling or even heating. In one example, the temperature control device 108 can be a thermal conduction cooling plate or the like for the chassis 10. Thus, the clamping force (i.e., along the direction of arrow B) provided by the engagement of the angled surfaces can also facilitate thermal contact between the bottom surface 24 of the chassis 10 and the temperature control device 108.

Although the foregoing description has discussed installing the chassis 10 generally from the front side, it is to be understood that the orientations and location of the clamping structure, wedge members, and wedge receiving members can be altered to permit the chassis 10 to be installed from various different sides, and/or to be secured to various supporting surfaces. The present application is intended to cover all such variations.

The invention has been described with reference to the example embodiments described above. Modifications and alterations will occur to others upon a reading and understanding of this specification. Examples embodiments incorporating one or more aspects of the invention are intended to include all such modifications and alterations insofar as they come within the scope of the appended claims.

What is claimed is:

1. A mounting assembly, including:
a chassis for receiving electronic components, including at least one face panel and a base panel;
a first wedge member coupled to the base panel of the chassis and including an angled surface;
a second wedge member coupled to the base panel of the chassis and including an angled surface, the respective angled surfaces of each of the first and second wedge members being oriented towards a common direction; and
a mounting plate adapted to be secured to a supporting surface, including:
a first wedge receiving element including a complementary angled surface adapted to receive to the angled surface of the first wedge member;
a second wedge receiving element including a complementary angled surface adapted to receive to the angled surface of the second wedge member;
an intermediate member coupling the first and second wedge receiving elements to maintain a fixed distance therebetween; and
clamping structure accessible from the at least one face panel and adapted to move the first and second wedge members towards the respective first and second wedge receiving elements such that engagement of the respective angled surfaces with the respective complementary angled surfaces applies a clamping force to the first and second wedge members.

2. The mounting assembly of claim 1, wherein the complementary angled surfaces of the first and second wedge receiving elements are angled generally upwardly to apply a generally downwardly directed force upon the first and second wedge members, respectively.

3. The mounting assembly of claim 1, wherein the base panel forms a bottom surface of the chassis.

4. The mounting assembly of claim 1, wherein at least one of the first and second wedge members includes at least one aperture adapted to receive a projection extending from the base panel.

5. The mounting assembly of claim 1, wherein the clamping structure includes at least one bolt extending through the at least one face panel.

6. The mounting assembly of claim 5, wherein the at least one bolt threadingly engages a threaded bore coupled to the first wedge receiving element, rotation of the bolt in a first direction drawing the first wedge member towards the first wedge receiving element.

7. The mounting assembly of claim 1, wherein the mounting plate is adapted to be secured to a supporting surface by at least one bolt.

8. The mounting assembly of claim 1, wherein the first wedge member further includes a plurality of angled surfaces with at least two of the plurality of angled surfaces being oriented at an angle relative to each other, and wherein the first wedge receiving element further includes a corresponding plurality of complementary angled surfaces adapted to receive the plurality of angled surfaces of the first wedge member.

9. The mounting assembly of claim 1, wherein the base panel includes a recess adapted to at least partially receive the mounting plate.

10. The mounting assembly of claim 1, further including:
a third wedge member coupled to the base panel of the chassis and including an angled surface oriented towards a common direction with the angled surface of the second wedge member; and
the mounting plate further including a third wedge receiving element including a complementary angled surface adapted to receive to the angled surface of the third wedge member, the third wedge receiving element being separated from the second wedge receiving element by the intermediate member.

11. A mounting assembly, including:
a chassis for receiving electronic components, including at least one face panel and a base panel;
a first wedge member coupled to the base panel of the chassis and including a plurality of angled surfaces with at least two of the plurality of angled surfaces being oriented at an angle relative to each other;
a second wedge member coupled to the base panel of the chassis and including an angled surface oriented towards a common direction with at least one of the plurality of angled surfaces of the first wedge member; and
a mounting plate adapted to be secured to a supporting surface, including:
a first wedge receiving element including a plurality of complementary angled surfaces adapted to receive the plurality of angled surfaces of the first wedge member;
a second wedge receiving element including a complementary angled surface adapted to receive to the angled surface of the second wedge member;
an intermediate member coupling the first and second wedge receiving elements; and
clamping structure accessible from the at least one face panel and adapted to move the first and second wedge members towards the respective first and second wedge receiving elements such that engagement of the respective angled surfaces with the respective complementary angled surfaces applies a clamping force to the first and second wedge members.

12. The mounting assembly of claim 11, wherein the complementary angled surfaces of the first and second wedge receiving elements are angled generally upwardly to apply a generally downwardly directed force upon the first and second wedge members, respectively.

13. The mounting assembly of claim 11, wherein the base panel forms a bottom surface of the chassis and includes a recess adapted to at least partially receive the mounting plate.

14. The mounting assembly of claim 11, wherein the clamping structure includes at least one bolt extending through the at least one face panel that threadingly engages a threaded bore coupled to the first wedge receiving element, rotation of the bolt in a first direction drawing the first wedge member towards the first wedge receiving element.

15. The mounting assembly of claim 11, further including:
a third wedge member coupled to the base panel of the chassis and including an angled surface oriented towards a common direction with the angled surface of the second wedge member; and
the mounting plate further including a third wedge receiving element including a complementary angled surface adapted to receive to the angled surface of the third wedge member, the third wedge receiving element being separated from the second wedge receiving element by the intermediate member.

16. A mounting assembly, including:
a chassis for receiving electronic components, including at least one face panel, and a base panel including a recess;
a first wedge member coupled to the base panel of the chassis and including an angled surface;
a second wedge member coupled to the base panel of the chassis and including an angled surface;
a third wedge member coupled to the base panel of the chassis and including an angled surface, the respective angled surfaces of each of the first, second, and third wedge members being oriented towards a common direction; and
a mounting plate at least partially receivable within the recess of the base panel and adapted to be secured to a supporting surface, including:
a first wedge receiving element including a complementary angled surface adapted to receive to the angled surface of the first wedge member;
a second wedge receiving element including a complementary angled surface adapted to receive to the angled surface of the second wedge member;
a third wedge receiving element including a complementary angled surface adapted to receive to the angled surface of the third wedge member;
an intermediate member coupling the first and second wedge receiving elements to maintain a fixed distance therebetween, the intermediate member being located between the second and third wedge receiving elements; and
clamping structure accessible from the at least one face panel and adapted to move the first, second, and third wedge members towards the respective first, second, and third wedge receiving elements such that engagement of the respective angled surfaces with the respective complementary angled surfaces applies a clamping force to the first, second, and third wedge members.

17. The mounting assembly of claim 16, wherein the complementary angled surfaces of the first, second, and third wedge receiving elements are angled generally upwardly to apply a generally downwardly directed force upon the first, second, and third wedge members, respectively.

18. The mounting assembly of claim 16, wherein the base panel forms a bottom surface of the chassis, and a portion of the bottom surface is adapted to be thermally coupled to a temperature control device.

19. The mounting assembly of claim 16 wherein the clamping structure includes at least one bolt extending through the at least one face panel that threadingly engages a threaded bore coupled to the first wedge receiving element, rotation of the bolt in a first direction drawing each of the first, second, and third wedge members towards the respective first, second, and third wedge receiving elements.

20. The mounting assembly of claim 16, wherein each of the first, second, and third wedge members each further include a plurality of angled surfaces with at least two of the respective plurality of angled surfaces being oriented at an angle relative to each other, and wherein the first, second, and third wedge receiving elements each further include a corresponding plurality of complementary angled surfaces adapted to receive the plurality of angled surfaces of the respective first, second, and third wedge members.
